(19) United States
(12) Patent Application Publication
(10) Pub. No.: US 2007/0012132 A1
(43) Pub. Date: Jan. 18, 2007

(54) VEHICLE LEVELING DEVICE

(76) Inventor: Daniel E. McConnell, Vero Beach, FL (US)

Correspondence Address: BOTKIN & HALL, LLP, 105 E. JEFFERSON BLVD., SUITE 400, SOUTH BEND, IN, 46601, US

(21) Appl. No.: 11/458,334

(22) Filed: Jul. 18, 2006

Related U.S. Application Data
(60) Provisional application No. 60/700,289, filed on Jul. 18, 2005.

(51) Int. Cl. F16H 1/24

(52) U.S. Cl. 74/424.71

(57) ABSTRACT

A vehicle leveling device includes an electric motor and a geared rod, mounted by way of a gearbox and mounting bracket to a vehicle frame. The geared rod is translatable through an upper retracted position and a lower extended position. The attached vehicle is supported when the geared rod touches the ground below through a foot mount. Power for the electric motor is provided from the attached vehicle itself.

### CROSS REFERENCE TO RELATED APPLICATIONS

This application claims the benefit of Provisional Application No. 60/700,289, filed Jul. 18, 2005.

### BACKGROUND OF THE INVENTION

1. Field of the Invention

The present invention relates generally to a vehicle leveling device suitable for recreational vehicles, motor homes, and trailers, and more particularly to an electric vehicle leveling device using a geared rod and gearbox for lifting and stabilizing a vehicle.

2. Description of the Background of the Invention

Recent advances have allowed electric motor lifts to become a convenient method of leveling stationary recreational vehicles, motor homes, and trailers. There have been several attempts at making electrical legs to level a vehicle.

U.S. Pat. No. 6,722,635 discloses a multiple screw jack with motor and gear assembly used for such purposes. However, the screw jack is limited in its overall throw of the screw and additionally mounts the motor and gear assembly above the frame of the vehicle it is used to lift.

In the system described in U.S. Pat. No. 5,826,889, an electrically operated leveler also describes a top-mounted electric motor which extends and retracts telescoping shafts to stabilize a vehicle.

Inherent in such devices that can be retrofitted to an existing vehicle is a limit to the throw of the shaft, because of the finite space from the frame of the vehicle to the ground below. Many current electric vehicle leveling systems suffer through a configuration having a top-mounted motor, causing the throw of the shaft or screw to be limited, as the motor takes up space below the vehicle that could be used for providing a leveling device with a longer shaft. One solution has been to adjust gear ratios in such devices, or add a number of shafts for stability. However, the lift is still limited by the motor's position at the very top of the leveling device.

### SUMMARY OF THE INVENTION

Accordingly, it is an object of the present invention to provide the advantage of greater throw of a shaft or screw for improved lifting of a vehicle.

It is another object of the present invention to provide flush mounting with a vehicle frame so as to limit the invasiveness of the leveling device on the current vehicle configuration when such leveling device is a retrofit appliance.

According to one aspect of the present invention, there is provided a vehicle leveling device including a geared rod mounted by way of a gearbox and mounting bracket to a vehicle frame.

In another aspect of the present invention, the geared rod of the device is translatable between upper and lower positions. In the lower extended position, the attached vehicle is supported when the geared rod touches the ground below by means of a foot mount. In the upper retracted position, the geared rod mounts inside a vehicle mounting bracket which remains flush, and not extending above, a vehicle frame.

The present invention in another aspect provides a gear train, which includes a gear, or worm wheel, meshing directly with the geared rod, or worm, providing translating movement of the geared rod from the electric motor, which is attachably connected to the gearbox. Power for the electric motor of the device is provided from the attached vehicle itself.

The above and other objects, features and advantages of the present invention will become apparent to those skilled in the particular art with the following description of illustrative embodiments thereof, to be read in conjunction with the accompanying drawings.

### BRIEF DESCRIPTION OF THE DRAWINGS

FIG. 1 is a front perspective view of a vehicle leveling device in detached form from a vehicle, shown in a retracted position.

FIG. 2 is a front perspective view of the vehicle leveling device in detached form from a vehicle, shown in an extended position.

FIG. 3 is a longitudinal sectional view of the vehicle leveling device, shown in a retracted position.

FIG. 4 is a longitudinal sectional view of the vehicle leveling device, shown in an extended position.

FIG. 5 is an additional longitudinal sectional view of the vehicle leveling device, shown in an extended position.

FIG. 6 is a top plan view of the vehicle leveling device.

FIG. 7 is a cross-sectional view of a gearbox of the vehicle leveling device.

### DETAILED DESCRIPTION OF INVENTION

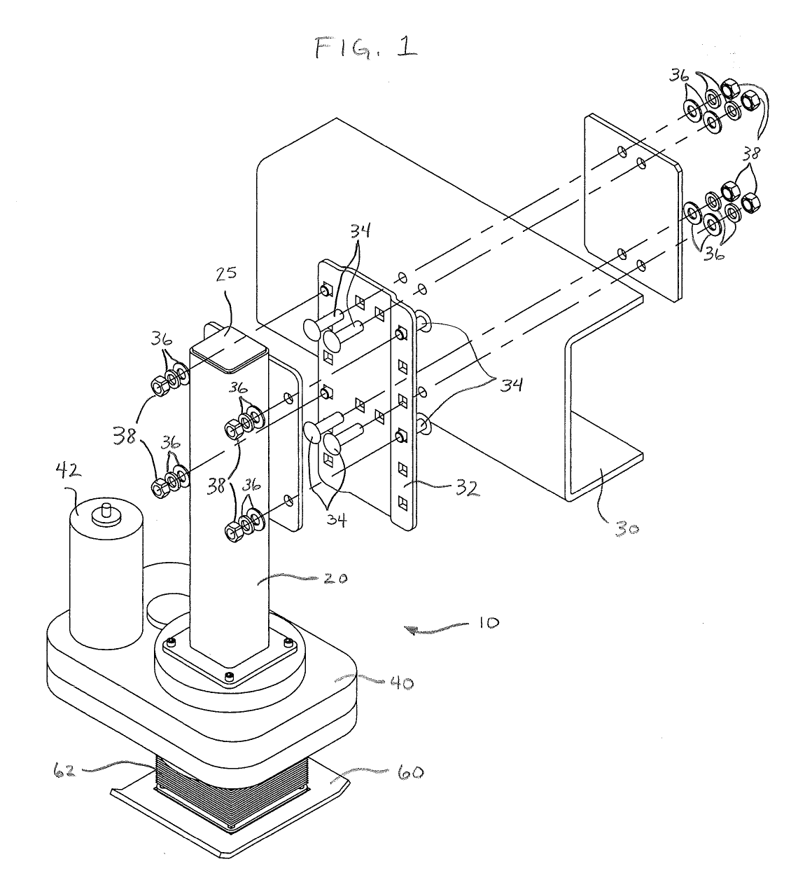

The embodiment illustrated in FIG. 1 shows a vehicle leveling device 10 for use in providing stationary support for a vehicle, such as a recreational vehicle, a motor home, a travel trailer, a fifth wheel, and other vehicles of the kind. As shown, the vehicle leveling device 10 includes a mounting bracket 20 which connects to a frame of a vehicle 30 and is joined, through any variety of brackets, illustrated here by bracket 32, bolts 34, washers 36, and nuts 38, to a gearbox 40.

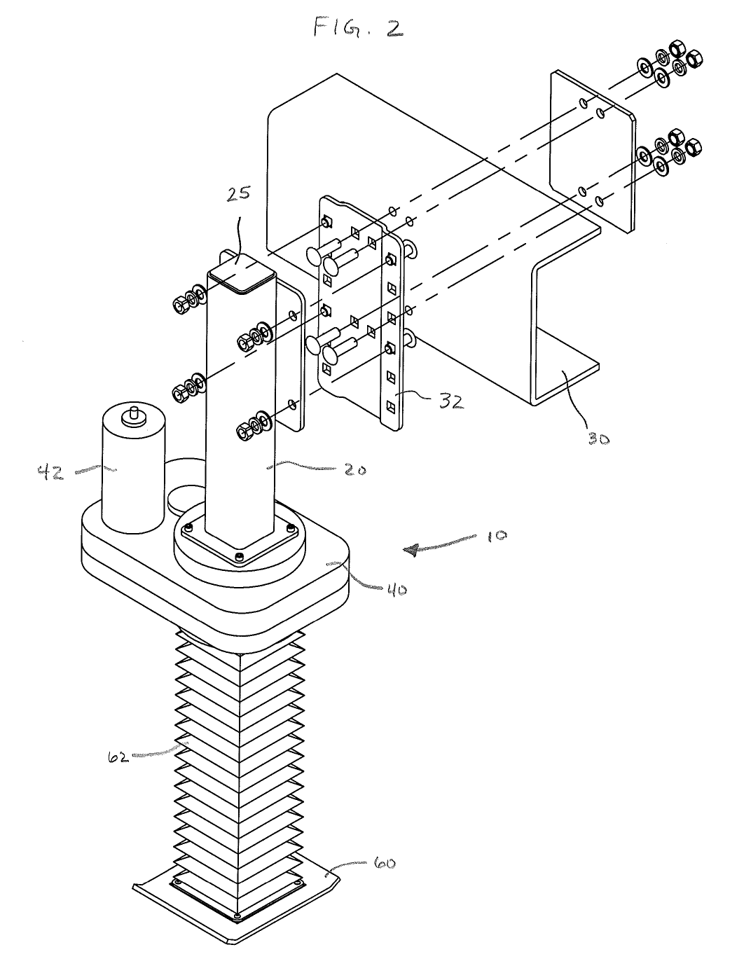

Preferably, an accordion-like geared rod cover 62 is joined to the bottom of the gearbox 40 and the top of a pivotable and detachable foot mount 60 to act as a shield when the vehicle leveling device 10 is extended toward the ground. As is seen in FIG. 2, when the vehicle leveling device 10 is extended, the foot mount 60 is pushed downward, causing the geared rod cover 62 to extend likewise.

To use the vehicle leveling device, the mounting bracket 20 is joined to the gearbox 40, preferably through a plurality of bolts. Mounting bracket 20 includes a housing 25 which extends between the gearbox 40 and the vehicle frame 30 when vehicle leveling device 10 is attached to a vehicle. The geared rod cover 62 is then joined to the gearbox 40, and the foot mount 60 is detachably joined to the geared rod cover 62. The entire device 10 is bolted to the frame 30 of a vehicle, preferably through a bracket 32 and mounting hardware: bolts 34, washers 36, and nuts 38.

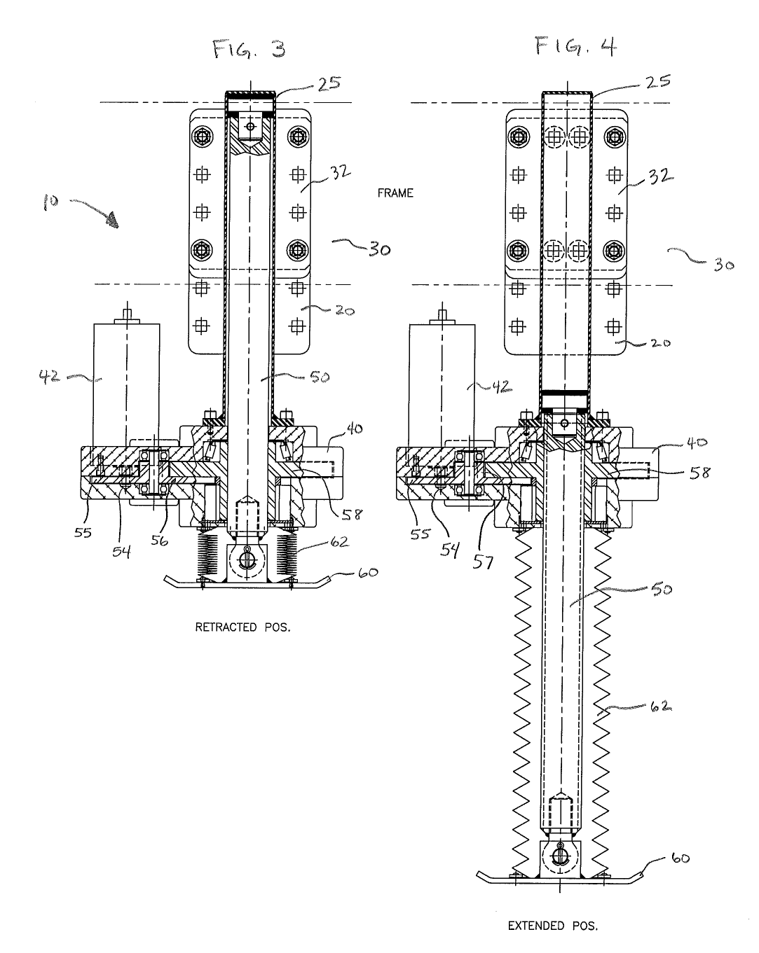

The geared rod cover 62 shields a geared rod 50 as it passes through the gearbox 40, as shown in FIG. 3. An electric motor 42, actuated by a voltage from an attached vehicle, such as a battery, provides the power necessary for powering the vehicle leveling device 10 through a gear train located in the gearbox 40.

As the vehicle leveling device 10 is engaged, as is seen in FIG. 4, the motor 42 powers the gear train of the gearbox 40, which in turn engages the geared rod 50. The geared rod 50 is sent downward through the gearbox 40 toward the ground below. The accordion-like geared rod cover 62 is extended as the foot mount 60 is pushed downward until contact with the ground below is made. This longitudinal movement of the vehicle leveling device 10 occurs from the upper retracted position shown in FIG. 3 in which the geared rod 50 extends fully into housing 25 to the lower extended position shown in FIGS. 4 and 5. According to the present invention, the vehicle leveling device 10 as illustrated can have at least a 6¼ inch throw of the geared rod 50.

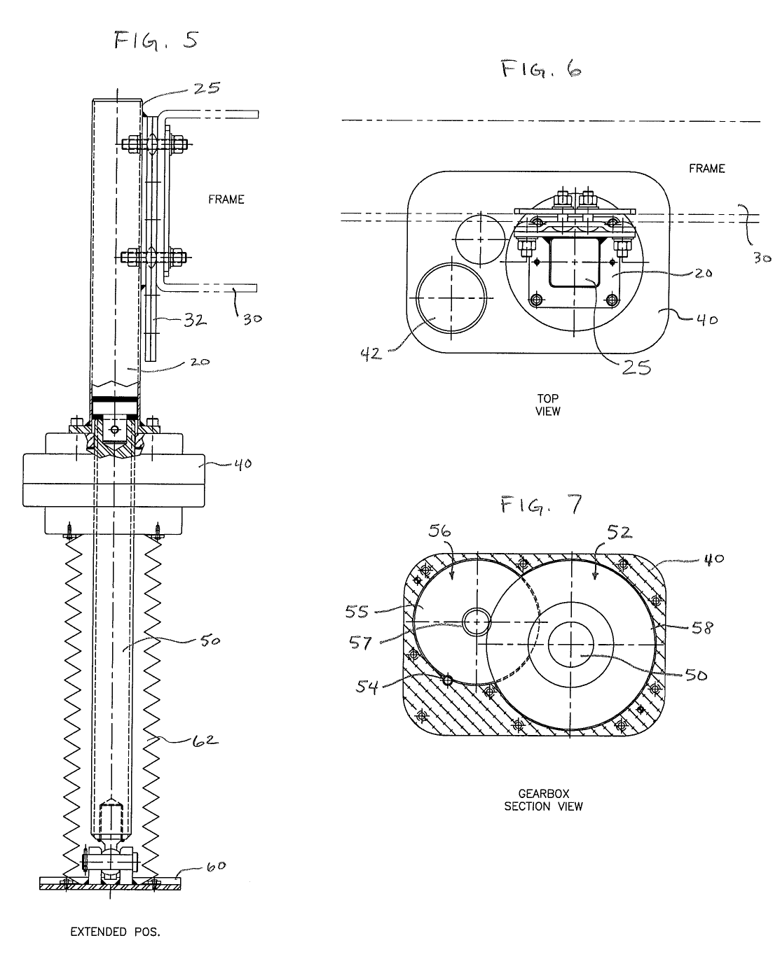

From a top view in FIG. 6, the gearbox 40 is shown with the electric motor 42 mounted in its position to provide power and torque to the geared rod 50. And as is seen from the sectional view of FIG. 7, the shaft of the electric motor 42 carries a pinion 54 which meshes with a larger diameter gear 55, the lower part of double gear 56. The smaller diameter gear 57, the upper part of double gear 56, then meshes with an adjacent worm gear 58. The worm gear 58 surrounds and meshes with the geared rod 50, or worm.

To lift the attached vehicle, the electric motor 42 is powered, causing rotation of the pinion 54, which meshes with the larger diameter gear 55, causing rotation of the double gear 56, of which the larger diameter gear 55 is the lower part. The upper part of double gear 56, the smaller diameter gear 57 meshes with worm gear 58, causing its rotation. Finally, worm gear 58 meshes with the geared rod 50 to push the rod 50 downward until the attached foot mount 60 contacts the ground below, providing the ultimate movement of the vehicle leveling device 10 to its extended position. The electric motor 42 can be reversed, with the plurality of gears moving in opposite rotations, to retract the geared rod 50 into the cavity of mounting bracket 20, providing the ultimate movement of the vehicle leveling device 10 to its retracted position.

The preferred embodiment described herein is not intended to limit or exhaust the scope of the present invention, but is illustrative as an example only. Modifications and alterations may be made by one skilled in the art without departing from the spirit or scope of the present invention, as defined in the following claims.

What is claimed is:

1. A leveling device, comprising:
a power source;
a mounting bracket for connection to a vehicle frame;
a gearbox joined to the mounting bracket;
a geared rod having upper and lower ends passing through the gearbox wherein the geared rod is vertically movable relative to the gearbox upon activation of said power source, said geared rod being raised relative to the gearbox for a retracted position of the leveling device and being lowered relative to the gearbox toward the ground below in an extended position of the leveling device; and
a foot mount joined to said geared rod at its lower end.

2. A leveling device according to claim 1, wherein the mounting bracket includes a housing receiving the geared rod when the leveling device is in its said retracted position.

3. A vehicle leveling device according to claim 2, and
a geared pinion rotatable by the power source,
the gearbox including a double gear having upper and lower parts,
the geared pinion meshing with the double gear lower part,
the double gear upper part meshing with a worm gear,
the worm gear meshing with the geared rod,
wherein rotation of the geared pinion causes translating movement of the geared rod to shift the leveling device between its said extended and retracted positions.

4. A vehicle leveling device according to claim 3, wherein said translating movement of the geared rod is at least 6¼ inches.

5. A vehicle leveling device according to claim 2, wherein the foot mount is pivotably connected to the geared rod and includes an accordion-like cover attachably connected between the gearbox and the foot mount.

6. A vehicle leveling device according to claim 1, wherein the power source is an electric motor.
